(19) United States
(12) Patent Application Publication
(10) Pub. No.: US 2026/0227847 A1
(43) Pub. Date: Aug. 6, 2026

(54) VIRTUAL CAMPUS FOR EXTENDED REALITY SERVICE INTEROPERABILITY

(71) Applicant: Saudi Arabian Oil Company, Dhahran (SA)

(72) Inventors: Fairouz Aldabbagh, Al Khobar (SA); Saud Alshammari, Dammam (SA); Norah Alageel, Dhahran (SA)

(21) Appl. No.: 19/045,940

(22) Filed: Feb. 5, 2025

(51) Int. Cl. G06F 3/01; G06T 19/00; G09B 5/02; H04L 65/1069; H04L 65/1089

(52) U.S. Cl. CPC G06F 3/012; G06T 19/006; H04L 65/1069; H04L 65/1089; G06T 2200/24; G06T 2219/024; G09B 5/02

(57) ABSTRACT

Methods and systems for a virtual three-dimensional campus for extended reality service interoperability. An authentication information for accessing a campus in a virtual reality system is processed. The campus includes multiple locations virtually accessible by a plurality of users relative to a user security level. Each location is associated with a respective extended reality (XR) content. A first user input including a selection of an XR content is received. The authentication information for connecting is securely transmitted and the XR content including a visualization of a digital twin matching an industrial equipment in a physical environment is launched. The visualization of the digital twin facilitates a team interaction; a second user input including a parameter modification of the digital twin is received. An implementation of the parameter modification to the industrial equipment in the physical environment is triggered.

### TECHNICAL FIELD

This specification generally relates to virtual reality devices and more particularly to a virtual three-dimensional campus for extended reality service interoperability.

### BACKGROUND

A typical way to view content on a conventional device is to open an application that can display the content on a display screen, such as a monitor of a computer, smartphone or a tablet. A user can navigate to the application to view the content. Traditionally, when the user is attempting to access the application an additional authentication step is performed. Within the context of industrial development hubs that support industrial development and testing capabilities that are offered as a cloud-based service, the display systems often suffer from fragmented user experiences due to inconsistent interfaces and varying levels of displays across different applications. Resource fragmentation can decrease productivity by introducing delays.

### SUMMARY

Innovative aspects of the subject matter described in this specification relate to a virtual three-dimensional campus for extended reality service interoperability.

In some implementations, a method includes: processing an authentication information for accessing a campus in a virtual reality system, wherein the campus includes a plurality of locations virtually accessible by a plurality of users relative to a user security level, each location of the plurality of locations being associated with a respective extended reality (XR) content, receiving a first user input including a selection of an XR content, securely transmitting the authentication information for connecting and launching the XR content including a visualization of a digital twin matching an industrial equipment in a physical environment, the visualization of the digital twin facilitating a team interaction, receiving a second user input including a parameter modification of the digital twin, and triggering an implementation of the parameter modification to the industrial equipment in the physical environment.

The foregoing and other implementations can each optionally include one or more of the following features, alone or in combination. In particular, implementations can include all the following features:

In a first aspect, combinable with any of the previous aspects, computer-implemented method further includes: displaying, the digital twin using a positional tag indicative of a physical location of industrial equipment in the physical environment. In another aspect, combinable with any of the previous aspects, the computer-implemented method further includes receiving, from the industrial equipment in the physical environment, a confirmation of the parameter modification, and updating the digital twin to match the industrial equipment in the physical environment. In another aspect, combinable with any of the previous aspects, the computer-implemented method further includes transmitting, to an external computing device, for display the parameter modification to the industrial equipment. In another aspect, combinable with any of the previous aspects, the external computing device includes a mobile device. In another aspect, combinable with any of the previous aspects, the computer-implemented method further includes displaying, a list of collaborators actively participating in the team interaction. In another aspect, combinable with any of the previous aspects, securely transmitting the authentication information for connecting and launching the XR content includes reformatting the authentication information for transmission. In another aspect, combinable with any of the previous aspects, the computer-implemented method further includes: determining a current perspective seen through the virtual reality system based on an orientation of a virtual reality device displaying the virtual reality system, and generating a three-dimensional information based on the current perspective.

Other implementations of the aspect include corresponding systems, apparatus, and computer programs, configured to perform the actions of the methods, encoded on computer storage devices.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features described herein, but also include any combination of the aspects and features provided.

The described approach is advantageous in that it enables seamless integration and communication between different extended reality (XR) applications and services within a unified virtual 3D environment (campus), where user access is implemented through a secure, single sign on authentication system that propagates user credentials across connected applications, eliminating redundant logins. The framework includes standardized protocols for real-time data exchange at the connectivity layer, unified user authorization verification that automatically validates access permissions across applications, enabling seamless data flow and content accessibility between multiple XR applications while maintaining secure user authentication boundaries. The described approach is built on an XR collaboration platform designed to enhance enterprise operations through artificial intelligence integration, which advantageously facilitates activation of effective preventative measures to avoid and/or correct predicted equipment failures.

Other implementations of this aspect include corresponding systems, apparatus, and computer programs recorded on computer storage devices, each configured to perform the operations of the methods.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

The accompanying drawings, which are incorporated in and constitute a part of this specification, show particular aspects of the subject matter disclosed herein and, together with the description, help explain some of the principles associated with the disclosed implementations. In the drawings,

FIG. 1A illustrates a scene of a virtual three-dimensional campus, according to some implementations of the present disclosure.

FIG. 1B illustrates a scene of a virtual three-dimensional campus with subzone identifiers, according to some implementations of the present disclosure.

FIG. 1C illustrates a scene of a virtual three-dimensional digital twin of an industrial equipment, according to some implementations of the present disclosure.

FIG. 1D illustrates a two-dimensional projection of the digital twin of the industrial equipment, according to some implementations of the present disclosure.

FIG. 2A illustrates an example implementation of a virtual reality system that includes integration of multiple devices, according to some implementations of the present disclosure.

FIG. 2B illustrates an example implementation of a virtual reality system for extended reality service interoperability, according to some implementations of the present disclosure.

FIG. 3 depicts a flow chart of an example process for displaying content within a virtual reality system, according to some implementations of the present disclosure.

FIG. 4 depicts a block diagram illustrating a computing system, in accordance with some example embodiments.

When practical, like labels are used to refer to same or similar items in the drawings.

### DETAILED DESCRIPTION

The following detailed description describes techniques for virtual reality systems. More particularly, implementations of the present disclosure are directed to virtual three-dimensional campus for extended reality service interoperability. The described implementations provide methods and systems for processing authentication information for accessing content in a virtual reality system. The virtual reality system presents a campus including a plurality of locations virtually accessible by multiple users, such as employees of an organization. Each location of the plurality of locations is associated with a respective extended reality (XR) content. A first user input including a selection of an XR content can be received. The authentication information is securely transmitted for connecting and launching the XR content including a visualization of a digital twin matching an industrial equipment in a physical environment. The visualization of the digital twin facilitates a team interaction. A second user input including a parameter modification of the digital twin is received. An implementation of the parameter modification to the industrial equipment is triggered in the physical environment.

The advent of virtual reality (VR) technology has revolutionized the way users interact with digital systems, offering immersive experiences that transcend traditional interfaces. Traditional integration of VR devices into system presents several limitations that limited their application in industrial settings. For example, traditional virtual reality systems often suffer from fragmented user experiences due to inconsistent interfaces and varying levels of immersion across different applications. The fragmentation can lead to delays that decrease productivity. Maintaining data consistency across virtual reality platforms has traditionally presented a significant challenge. Discrepancies in data synchronization can result in outdated or conflicting information being presented to users, undermining the reliability of the system. Managing applications within a virtual reality environment is inherently complex. For supporting a wide range of virtual reality devices and software versions, virtual reality systems add layers of complexity to application deployment, updates, and maintenance. Virtual reality systems can require substantial computational resources, impacting the overall system efficiency.

Integration of virtual reality devices with existing industrial systems and workflows can pose significant challenges. For example, compatibility issues and varying communication protocols can hinder component integration, limiting the potential benefits of virtual reality technology in industrial applications. Traditional virtual reality systems can be designed for generic communication without being adaptable to industry-specific scenarios. The immersive nature of virtual reality environments can also introduce unique security concerns. Unauthorized access, data breaches, and the potential for malicious software to exploit virtual reality systems are critical issues that can be addressed to protect sensitive information and ensure user safety. Developing applications for virtual reality systems can be inherently complex, especially for integrating high-performance applications that can operate across diverse hardware and software environments, which add to the development burden.

The techniques described in the present disclosure provide seamless integration and communication between different extended reality (XR) applications and services within a unified virtual 3D environment (campus) providing access to an industrial zone for seamless management of industrial equipment. An advantage of the described technology is that user access is implemented through a secure, single sign on authentication system that propagates user credentials across connected applications, eliminating redundant logins. The framework includes standardized protocols for real-time data exchange at the connectivity layer, unified user authorization verification that automatically validates access permissions across applications, enabling seamless data flow and content accessibility between multiple XR applications while maintaining secure user authentication boundaries. Another advantage of the described technology is that the described system is built on a middleware platform coupled to an XR collaboration platform designed to enhance industrial operations through artificial intelligence integration. The described technology advantageously provides automatic implementation of preventative measures by triggering of automatic operations for systems and machines configured to maintain reliable, safe, and continuous oil and gas operations. The preventative measures can include automatically adjusting operational states (e.g., opened or closed states) of industrial equipment components, such as pumps and valves.

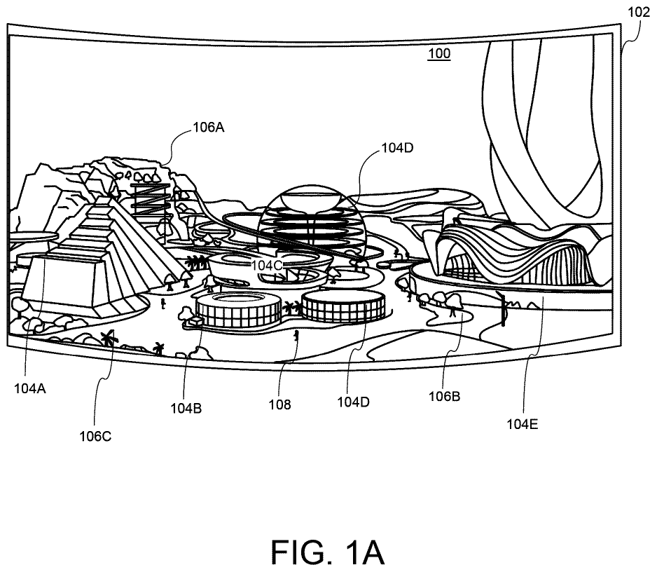

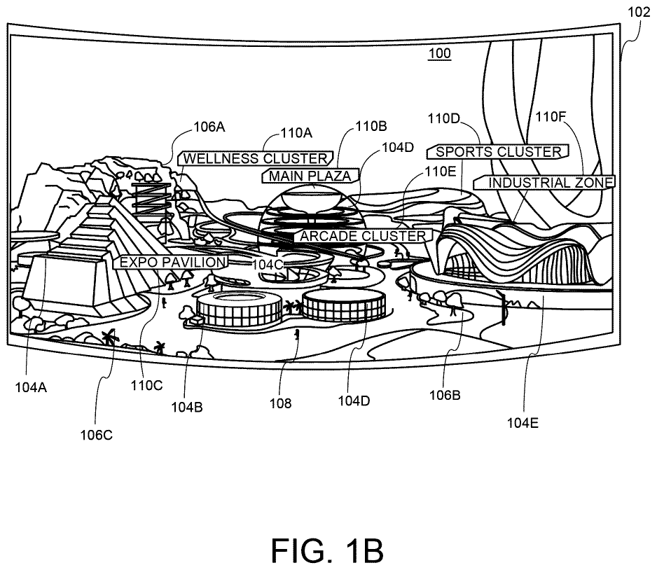

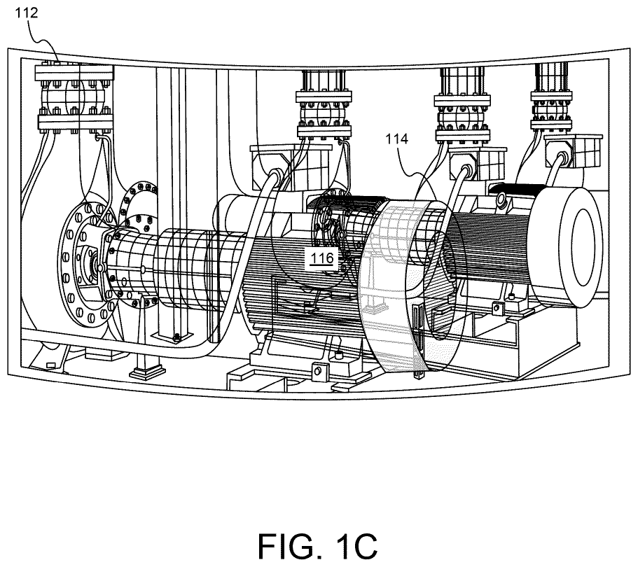

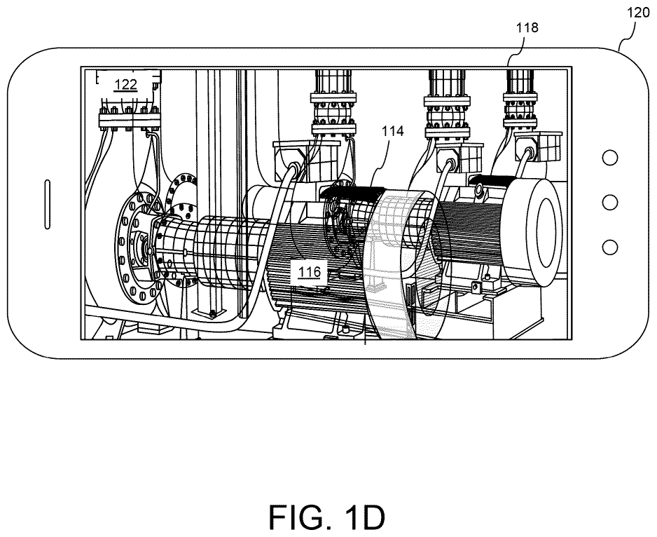

FIG. 1A illustrates a scene of a virtual three-dimensional campus 100, according to some implementations of the present disclosure. The scene of a virtual three-dimensional campus 100 can be displayed by a head-mounted virtual reality (VR) system 102 is used. The head-mounted VR system 102 can be a virtual reality or a mixed reality device that presents to the user an interface for interacting with and experiencing a virtual reality world that can match as representation a physical world. The virtual reality world can include middleware platform generated content and virtual representation of real-world physical objects in the user's physical environment or remote from user's physical environment. The head-mounted VR system 102 can provide images of a virtual campus that accurately reflects the layout, architecture, and aesthetics of a physical campus, such as a work environment of an organization.

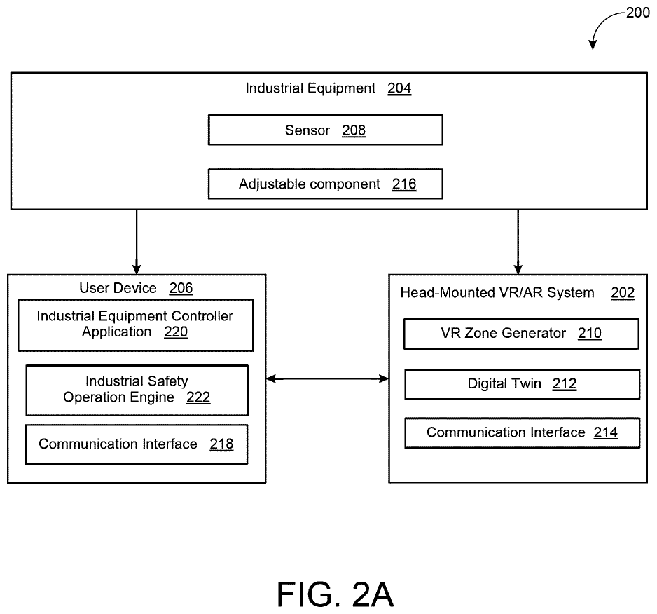

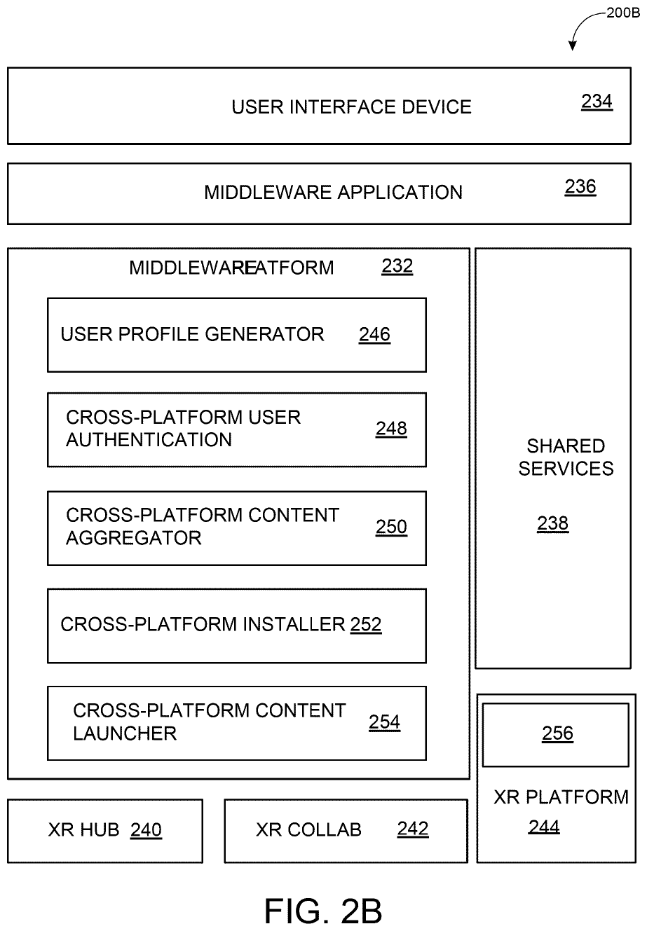

The virtual three-dimensional campus 100 can be hosted by a middleware platform (e.g., an Arthur platform), as described with reference to FIGS. 2A and 2B. The virtual three-dimensional campus 100 can be seen by multiple users, each user seeing the virtual three-dimensional campus 100 through a respective eye piece(s) of the head-mounted VR system 102. For example, a binocular eye view as seen through eye pieces of the head-mounted VR system 102 is shown. The eye pieces of the head-mounted VR system 102 can be completely opaque to serve as all-around optical displays of the virtual environment or can be at least partially transparent to serve as “optical see-through” displays through which the user can view real objects in the user's physical environment.

The virtual three-dimensional campus 100, as seen in the binocular eye view 102, can form a virtual plaza area that includes multiple buildings 104A-104E and other spatial features 106A-106C defining the zones between buildings. The spatial features 106A-106C can include pathways 106C towards the buildings 104A-104E, interactive features, seating areas, and landscape elements that create a vibrant and welcoming atmosphere. An avatar 108 (virtual representation of a user of the head-mounted VR system 102 or of a user of another head-mounted VR system) can be displayed as being located within one of the spatial features 106A-106C. For example, the head-mounted VR system 102 can produce images of avatars which are moving along pathways 106C towards one of the buildings 104A-104E.

FIG. 1B illustrates a scene of a virtual three-dimensional campus 100 with subzone identifiers 110A-110F, according to some implementations of the present disclosure. The subzone identifiers 110A-110F can be selected to trigger a seamless transition to access a respective subzone. Each zone can be characterized by a particular immersive experience. All subzones can include experiences hosted on XR Hub.

The zones can include a learning center zone displaying a virtual learning center within the virtual three-dimensional campus 100, providing a virtual environment for educational activities. A user can launch the XR Hub-hosted simulation from the new learning center that is hosted on middleware platform, and return once exiting the simulation. The learning center zone can include workshop and auditorium templates to cater for live learning sessions, by collaborating with the directing team and adhering to middleware platform guidelines.

The zones can include a plaza zone serving as a central gathering space within the virtual three-dimensional campus 100, ensuring compliance with the platform guidelines. The plaza zone includes interactive features, seating areas, and landscape elements that create a vibrant and welcoming atmosphere.

The zones can include an industrial park zone that facilitates access to digital twins of industrial equipment and collaboration between users within a team, simulating an industrial environment in accordance with a physical industrial system. The industrial park zone can include the industrial hub subzone that can host facility digital twins that are hosted on either middleware platform or XR Hub. The industrial park zone can include templates of virtual laboratories, industrial plants (e.g., control rooms of oil drilling and oil management equipment), offices, meeting rooms, and networking spaces to facilitate professional interactions, following the creative direction provided by the design directing team and ensuring compatibility with the XR collaboration platform.

The zones can include an exhibition zone that facilitates a team to design and develop a virtual exhibition area to showcase products, innovations, and exhibitions within the campus, adhering to the platform guidelines. The exhibition zone experiences can be hosted on the XR Hub and upon completion, a user of the VR system can return to the plaza zone.

The zones can include a recreation zone that provides a user or a team to access the recreation zone, consisting of three subzones: wellness center, arcade, and sports stadium, following the platform guidelines. The recreation zone provides a virtual wellness center with features promoting health, relaxation, and fitness activities, following the creative direction provided by the design directing team and ensuring compatibility with the XR collaboration platform. The recreation zone provides a virtual arcade with a variety of interactive games and entertainment options, following the creative direction provided by the design directing team and adhering to the platform's compatibility requirements. The recreation zone provides a virtual sports stadium for hosting virtual sports events and competitions, following the creative direction provided by the design directing team and in accordance with the XR collaboration platform guidelines.

The virtual content within any of the zones can include or correspond to a respective application displaying digital pictures and/or videos of particular objects including industrial assets, to name a few examples. Virtual digital content can correspond to content stored on a storage device that is accessible by the head-mounted VR system 102 or virtual content can be a presentation of streaming content, such as a live video feed. Multiple items of virtual content can be virtually displayed on multiple, different physical surfaces in the virtual three-dimensional campus 100, to increase an overall workspace area for the user onto which virtual content can be displayed. Various planar surfaces can be designated as virtual displays, for example.

FIG. 1C illustrates a scene of an industrial park zone 112 including a virtual three-dimensional representation of a digital twin 114 of an industrial equipment, according to some implementations of the present disclosure. The digital twin 114 can include a control panel 116 that enables adjustment of one or more operations of an industrial equipment located in a physical environment. The digital twin 114 can be virtually displayed within a field of view of the head-mounted VR system, being accessible from any surrounding position, to enable virtual inspection of the digital twin 114 that can be displayed in real time as seen by one or more cameras focused on the associated industrial equipment located in a physical environment. Virtual displaying of content, as described herein, refers to displaying content on a display system or device (such as the right eye piece 104), such that the content appears to the user to be displayed as an overlay at a particular three dimensional location in the physical environment. The head-mounted VR system 102 can be configured such that when the user turns the head or looks up or down, display devices within the head-mounted VR system 102 adjust the rendering of the virtual content within the industrial park zone 112 so that it appears that the view of the digital twin 114 changes, similar to a modified view in the physical environment.

FIG. 1D illustrates a two-dimensional projection of the digital twin 114 of the industrial equipment, according to some implementations of the present disclosure. The two-dimensional projection of the digital twin 114 can be displayed by a user device 120 remotely located from the head-mounted VR system 102. The head-mounted VR system 102 or the user device 120 can make an internal determination that new content is available and/or can receive a notice from an external system that new content is available to enable collaboration for managing industrial equipment, for example.

The new content can be various types of pushed content. Pushed content can be content that can be rendered into the user's displayed environment without the user having to search for or select the content. For example, pushed content can include (a) notifications from various applications such as stock notifications (operational alerts); (b) prioritized content, for example, updates and notifications from applications, email updates, or messages from contacts; (c) messages targeting broad target groups and/or specific target groups; or d) other types of content or content streams to enable collaboration between users.

In response to determining that a new content item is available for virtual display, a notification 122 can be displayed to the user. The notification 122 indicates that an industrial equipment has an updated operational parameter to prevent a predicted risk. The notification 122 can be virtually displayed to the user by the head-mounted VR system 102 and/or the user device 120. The notification 122 can be shown on a particular physical surface within the virtual three-dimensional campus 100, or can be displayed as if appearing “in space.” Other examples include the notification 122 being displayed on a physical display of a industrial equipment or as an audio notification to the user (e.g., as played through speakers of the head-mounted VR system 102 or another connected computing device).

The user can configure various settings for controlling the display of the notification 122 and other new content notices. For instance, the user can configure a particular location (e.g., physical surface, physical computing device display) on which to virtually display new content notifications. As another example, the user can configure notification frequency (e.g., display immediately, display periodically) and content type(s) for which to display notices.

The user can interact with the notification 122 to indicate acceptance/confirmation of the notification 122 and/or to initiate selection of a location (e.g., within the physical environment of the virtual three-dimensional campus 100) on which to virtually display the new content or content stream. The user can select a particular location in a variety of ways. One approach for selecting a location is by using a user interface displayed on a mobile user device 120. The user interface 118 can be a simplified representation of the virtual three-dimensional campus 100 or of the industrial park zone 112 including a virtual three-dimensional representation of a digital twin 114 of an industrial equipment. For example, the user interface 118 can display a digital planar map (e.g., a “mini map”) of the virtual three-dimensional campus 100 enable cross-platform collaboration.

The user device 120 can be used as a controller, control panel, and/or navigator for the VR environment. For instance, the user can interact with the user interface 118 for placement of virtual content. Existing virtual content can be represented in the user interface 118 by an object or icon. For instance, the virtual content of FIG. 1A is represented in the user interface 118 as an icon 152. The user can select the icon 152 and drag the icon 152 to another location within the user interface 118. In response to a moving of the icon 152 to another location within the user interface 118, the virtual content can be displayed as an overlay at a corresponding location within the AR environment as seen by the user using the head-mounted VR system 102.

FIG. 2A illustrates an example implementation of a VR system 200A that includes integration of multiple devices, according to some implementations of the present disclosure. FIG. 2A illustrates an example implementation of an VR system 200 that includes mobile device integration. A head-mounted VR system 202 can be configured to monitor and control operations of an industrial equipment 204 to maintain the safety of the industrial equipment 204 in the physical environment. The head-mounted VR system 202 can be configured to communicate with a user device 206 configured to display a status of the industrial equipment 204 within the physical environment.

The head-mounted VR system 202 can receive a notification from a sensor 208 that a new measurement (sensor data) that is outside a threshold, is available for virtual display by the head-mounted VR system 202. The VR zone generator 210 can subscribe to and receive notifications from the sensor 208 and can generate a virtual content item for displaying the new content by the head-mounted VR system 202. The virtual content item can be displayed by the head-mounted VR system 202 so that it virtually appears to the user while being at a default location (e.g., virtual industrial zone) or the virtual content item can be displayed so that it virtually appears to the user, independent of a virtual zone being accessed. The head-mounted VR system 202 can display the digital twin 212 associated with the industrial equipment 204. The head-mounted VR system 202 can facilitate an interaction with the digital twin 212, as described with reference to FIG. 1C. The equipment adjustments applied to the digital twin 212 can be transmitted by the communication interface 214 to the industrial equipment 204, which applies them to the adjustable component 216 and to the user device 206.

In some examples, the adjustable component 216 includes a variable frequency drive, a control valve, a diaphragm valve, a pressure reducing valve or an actuated valve to regulate a flow of a fluid in an industrial plant. Control valves can regulate the flow, pressure, temperature, and level of fluids or gases in the industrial system. The control valves can include globe valves for precise flow control, especially in high-pressure systems, ball valves for quick and tight shut-off with minimal leakage, butterfly valves for large volume flow control with low-pressure drop. Variable frequency drives are used to control the speed of pumps and fans by adjusting the frequency and voltage supplied to the electric motor. Variable frequency drives are help in optimizing energy consumption and maintaining safe flow rates. Pressure reducing valves can automatically reduce a higher inlet pressure to a lower, stable outlet pressure, ensuring consistent flow rates and protecting downstream equipment. Flow control valves can precisely regulate the flow of liquids or gases at high pressure levels, functioning as both flow controllers and pressure regulators. Actuated valves these valves are equipped with actuators (pneumatic, electric, or hydraulic) that receive signals from a control system to adjust the valve position, ensuring precise flow control.

In some examples, the adjustable component 216 includes a machine component for controlling drilling in an oil well, such as choke valves, downhole safety valves, subsurface control valves, adjustable gas lift valves, surface control valves, or a well head. Choke valves are critical for controlling the flow rate of oil and gas from the well. The choke valves can be adjusted to manage the pressure and flow, ensuring safe and efficient production. Downhole safety valves are installed in the wellbore and can be adjusted to shut off the flow of fluids in case of an emergency, preventing blowouts and ensuring well integrity. Subsurface control valves are used to control the flow of fluids within the wellbore. The subsurface control valves can be adjusted to regulate production rates and manage reservoir pressure. Adjustable gas lift valves are used in gas lift systems to control the injection of gas into the well, which helps in lifting the oil to the surface. The adjustable gas lift valves can be adjusted to optimize the flow rate and improve production efficiency. Surface control valves are located at the wellhead and can be adjusted to control the flow of fluids from the well to the surface facilities. The surface control valves manage production rates and ensuring safe oil drilling operations. Within the context of oil drilling, the adjustment can include a modification of an angle and velocity of the well head for maintaining safe oil drilling operations.

The communication interface 214 of the head-mounted VR system 202 can send information to the communication interface 218 of the user device 206, to enable the user device 206 to execute the industrial equipment controller application 220. The industrial equipment controller application 220 can be coupled with the adjustable component 216 of the industrial equipment 204 to display and adjust a status of the adjustable component 216. The industrial safety operation engine 222 can receive and process sensor data received from the sensor 208 and the status of the adjustable component 216 to predict operational risks. The industrial safety operation engine 222 can include an artificial intelligence (AI) model trained to classify operational patterns of the industrial equipment 204, identify operational risks, and provide action plans for maintaining safe operations. The industrial safety operation engine 222 can generate notifications indicating the operational risks and the corresponding action plans for maintaining safe operations. The industrial safety operation engine 222 can transmit, using the communication interface 218, the notifications to the head-mounted VR system 202. Any adjustments entered by the head-mounted VR system 202 or the user device 206 affecting the industrial equipment 204 are visible both on the head-mounted VR system 202 and the user device 206.

FIG. 2B illustrates an example implementation of a VR system 200B for extended reality service interoperability, according to some implementations of the present disclosure. The VR system 200B includes a middleware platform 232, a user interface device 234, a middleware platform application engine 236, shared services 238, a XR hub 240, a XR collaboration engine 242, and a XR platform 244.

The middleware platform 232 is a virtual platform that functions as a middleware/central hub that consolidates various services like account generator and application deployment within a digital environment. The integrated ecosystem of the middleware platform offers cross-platform functionality through its authentication, content aggregator, installer and launcher features that enable a cohesive operational framework where users can engage and interact with these services through a single interface.

The user interface device 234 includes any computing device, such as a virtual reality headset, a mixed reality system, a server, a desktop computer, a laptop/notebook computer, a wireless data port, a smart phone, a personal data assistant (PDA), a tablet computing device, or one or more processors within these devices, including physical instances, virtual instances, or both. The user interface device 234 can include input devices such as keypads, keyboards, and touch screens that can accept user information. The user interface device 234 can include output devices that can convey information associated with interactions with the middleware platform 232. The information can include digital data, visual data, audio information, or a combination of information. The information can be presented in a three-dimensional virtual (VR)/augmented (AR) or two-dimensional graphical user interface.

The middleware platform application engine 236 provides the client application that enables access to the virtual campus, described with reference to FIGS. 1A and 1B. The middleware platform application engine 236 is designed to facilitate seamless access to a three-dimensional representation of the virtual campus through a client application. The middleware platform application engine 236 manages user profiles, ensuring personalized experiences within the three-dimensional virtual campus. The middleware platform application engine 236 stores user preferences, access rights, and interaction history to provide a tailored environment for each user. The middleware platform application engine 236 synchronizes data in real-time between the virtual campus and the backend systems. The middleware platform application engine 236 ensures that users have access to the most up-to-date information, enhancing the reliability and accuracy of the virtual environment. The middleware platform application engine 236 delivers interactive content within the three-dimensional virtual campus, including multimedia presentations, simulations, and collaborative tools. The middleware platform application engine 236 enhances user engagement and facilitates immersive learning and collaboration experiences. The middleware platform application engine 236 is designed to handle a large number (hundreds or thousands) of concurrent users, ensuring smooth performance and scalability. The middleware platform application engine 236 optimizes resource allocation and load balancing to maintain a high-quality user experience even during peak usage times. The middleware platform application engine 236 integrates with external systems such as learning management systems (LMS), enterprise resource planning (ERP) systems, and other enterprise applications for seamless data exchange and interoperability, enhancing the functionality of the 3D virtual campus.

The middleware platform 232 includes a user profile generator 246, a cross-platform user authentication 248, a cross-platform content aggregator 250, a cross-platform installer 252, and a cross-platform content launcher 254. The middleware platform 232 can be accessed by multiple end-user devices that can be used to access the experience. The middleware platform 232 can include artificial intelligence models designed to enhance enterprise operations through advanced artificial intelligence integration. The middleware platform 232 platform can be designed to enhance enterprise collaboration through immersive virtual reality (VR) environments.

The middleware platform 232 offers fully customizable virtual office spaces that can be tailored to fit various use cases, from small team meetings to large-scale conferences. The platform integrates artificial intelligence to enhance productivity by assisting users with real-time analyses, with note-taking, and with providing actionable insights. The middleware platform 232's artificial intelligence can guide teams through structured workflows, ensuring efficient and impactful meetings. The middleware platform 232 ensures secure collaboration with end-to-end encryption, multi-factor authentication, and high-frequency backups. The middleware platform 232 can be service organization controls (SOC) cybersecurity compliant. The platform supports dynamic meetings with hundreds of active participants, making it suitable for large organizations. Users can access the middleware platform 232 from various devices, including VR headsets from Meta, HTC, Pico, and Lenovo, as well as 2D devices via browsers. The middleware platform 232 aims to transform digital collaboration by combining the immersive nature of VR with the efficiency of AI, providing a seamless and productive virtual workspace.

The user profile generator 246 can create user profile in the middleware platform and can synchronize the user profile with all XR Platforms 244 through the shared services platform 238. The user profile generator 246 collects and stores user information, preferences, and settings, ensuring a personalized experience across different platforms. The user profile generator 246 facilitates a consistent user identity and preferences management, enhancing user experience and system efficiency.

The cross-platform user authentication 248 can process authentication information through single sign-on (SSO) to authenticate through all platforms. The cross-platform user authentication 248 can provides secure authentication mechanisms across multiple platforms. The cross-platform user authentication 248 supports various authentication methods, such as Open Authorization (OAuth) standard, Security Assertion Markup Language (SAML), and multi-factor authentication (MFA), ensuring that users can securely access the system regardless of the device or platform they are using. The cross-platform user authentication 248 enhances security and simplifies the login process for users of the VR system 200B.

The cross-platform content aggregator 250 can aggregate (collect and consolidate) the middleware platform content to be displayed in the universal menu from all XR Platforms. The cross-platform content aggregator 250 ensures that users of the VR system 200B have access to a unified content repository, regardless of the original source. The cross-platform content aggregator 250 helps in maintaining data consistency and provides users of the VR system 200B with a seamless content experience across different platforms.

The cross-platform installer 252 can enable installation of XR content from other XR Platforms 244 through the middleware platform 232. The cross-platform installer 252 manages the installation of applications and updates across multiple platforms. The cross-platform installer 252 ensures that the correct versions of software are installed and maintained, reducing compatibility issues and simplifying the deployment process. The cross-platform installer 252 automates the installation process, making the installation easier for users of the VR system 200B to set up and update their applications.

The cross-platform content launcher 254 can enable interoperability between platforms through bidirectional deep linking. The cross-platform content launcher 254 enables users to access and launch content and applications from a unified interface, regardless of the platform. The cross-platform content launcher 254 provides a consistent user experience by allowing users to interact with the content and applications seamlessly. The cross-platform content launcher 254 component enhances usability and ensures that users can easily access the tools and information corresponding to different zones of the campus, and stores information associated with a last visited place within a zone, to facilitate return to the previous place, when returning to a previously visited zone.

The shared service platform 238 provides integration with third party services such as LMS, SSO, digital identity, digital wallet, and internet of things.

The XR hub 240 acts as a central point for managing and distributing XR content. The XR hub 240 handles the integration of various XR applications and ensures that users can access a wide range of immersive experiences. The XR hub 240 enhances the scalability and flexibility of the VR system. An integration between the middleware platform 232 and XR Hub 240 is required to create a seamless experience between the two platforms. While The middleware platform 232 (e.g., Arthur platform) is a Unity-based solution, the XR Hub 240 is an XR content management platform that can host Unreal or Unity applications.

The XR collaboration engine 242 facilitates real-time collaboration within the XR environment. The XR collaboration engine 242 supports multi-user interactions, shared workspaces, and collaborative tools, enabling users to work together seamlessly in the virtual space. The XR collaboration engine 242 enhances optimization of operations (including industrial plant safety), productivity, and teamwork.

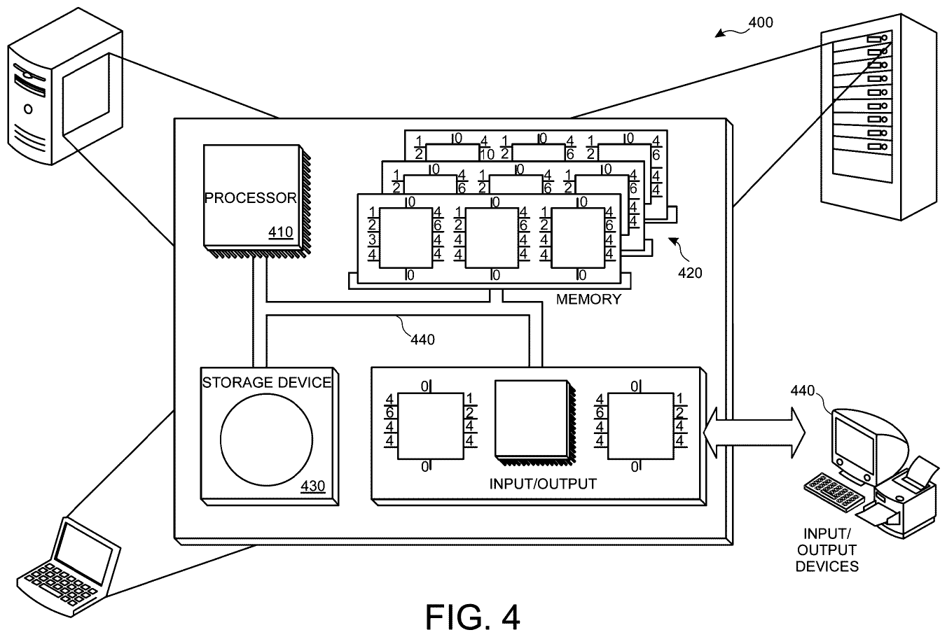

The XR platform 244 provides the underlying infrastructure for running XR applications. The XR platform 244 includes the hardware and software resources to support high-performance, immersive experiences (as described with reference to FIG. 4). The hardware resources include VR/AR headsets (e.g., devices such as the OCULUS RIFT, HTC VIVE, MICROSOFT HOLOLENS, and META QUEST), sensors and trackers (e.g., external cameras, infrared sensors, and motion trackers that detect user movements and interactions within the virtual space), computing devices (e.g., high-performance computers or standalone devices with powerful GPUs (graphics processing units) are essential for rendering complex three-dimensional environments and processing real-time interactions), haptic feedback devices (e.g., devices that provide tactile feedback to users, enhancing the sense of touch within the virtual environment, such as haptic gloves and vests that simulate physical sensations), and industrial equipment included in an industrial plant of the physical environment. The hardware resources ensure accurate tracking and enhance the realism of the XR experience, provide high-resolution displays, spatial audio, and motion tracking to create immersive environments.

The software resources of the XR platform 244 include XR operating systems including platforms like Android XR and Horizon OS that provide the underlying software infrastructure for running XR applications. The software resources of the XR platform 244 manage hardware resources, support app development, and ensure compatibility across devices. The software resources of the XR platform 244 include development frameworks, such as tools that create XR content. The frameworks offer robust libraries, APIs, and development environments for building interactive and immersive applications. The software resources of the XR platform 244 include content management systems, such as systems handle that the storage, organization, and distribution of XR content. The content management systems ensure that users can access and interact with a wide range of virtual experiences seamlessly. The software resources of the XR platform 244 include artificial intelligence models 256 (e.g., machine learning models) that provide prediction-driven functionalities, such as contextual assistance and natural language processing, enhance user interactions within the XR environment. The artificial intelligence models 256 enable more intuitive and responsive experiences. The XR platform 244 ensures that the VR system can deliver rich and engaging content to users. The middleware platform 232, the XR hub 240, and the XR platform 244 can include middleware solutions that can bridge the gap between middleware applications 236, such as UNITY'S XR INTERACTION TOOLKIT and UNREAL's VR frameworks that standardize interactions across different platforms. The middleware platform 232, the XR hub 240, and the XR platform 244 can include application programming interfaces (APIs) and software development kits (SDKs) that can enable smooth data exchange and functionality integration. The APIs and SDKs allow custom solutions that leverage the strengths of both platforms. The middleware platform 232, the XR hub 240, and the XR platform 244 can include cloud-based services that can host and manage XR content, ensuring that middleware applications 236 can be accessed and interacted with in a unified environment.

The VR system 200A, 200B provides multiple advantages by eliminating repeated authentications using multiple logins and disparate user interfaces by providing a unified login system by integrating a cross-platform authentication that unifies access control. The VR system 200A, 200B includes a content aggregator that unifies content from various sources, reducing duplication and conflicts. The VR system 200A, 200B advantageously includes a cross-platform installer that simplifies deploying/managing applications across divers environments, reduces installation errors, and ensures compatibility. The VR system 200A, 200B advantageously includes a content launcher that unifies access to XR applications, improving accessibility. The VR system 200A, 200B advantageously provides accommodation for shared services that simplifies the exchange of information and functionalities across different systems. The VR system 200A, 200B advantageously provides a consistent platform, guidelines and tools for developers, simplifying the development process for multi-platform applications. The VR system 200A, 200B also offers centralized updates and support, reducing downtime and operational overhead.

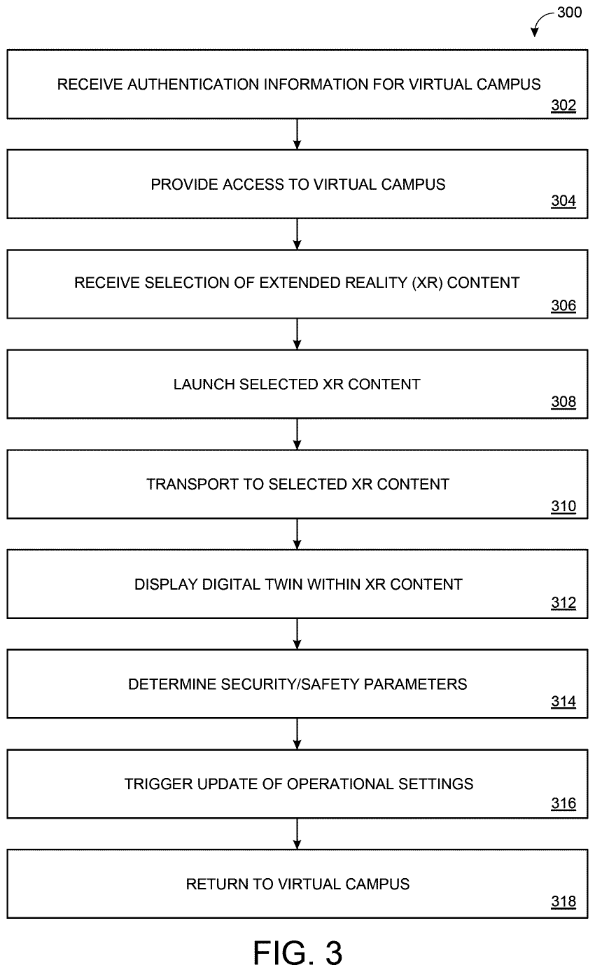

FIG. 3 depicts a flow chart of an example process 300 for displaying content within an VR system, according to some implementations of the present disclosure. Referring to FIGS. 1A, 1B, 2A, 2B, and 4, the example process 300 can be performed by any components of the example systems 100, 200, and 400.

At 302, an authentication information for accessing content in a virtual reality system is received. The virtual reality system includes a campus including multiple zones and locations virtually accessible by multiple users, each location of the plurality of locations being associated with a respective extended reality (XR) content. The functional zones host a particular metaverse use case. The zones can include Arthur-hosted spaces or XR Hub-hosted simulations. Each functional zone can be displayed as having a unique architecture that can match a physical architecture in a physical environment. The functional zones can include an industrial zone. The campus can include shortcuts (defined as shortest pathways) to each of the functional zones.

At 304, the authentication information is processed to provide access to the content in the virtual reality system, relative to a security level of the user. The authentication information can include user identifiers including a username, a user password, and, optionally, third factor authentication (e.g., biometric data, token, codes, etc.). Authentication information processing includes execution of authentication protocols (e.g., OAuth, SAML) to securely transmit and verify user credentials. Authentication information processing can include generation of an access token. that is a temporary digital key that grants the user access to particular content or features. The access token remains can be set to remain valid during the duration of the session such that the user can seamlessly access the campus content and each of the zones. The security level of the user determines the functional zones that are displayed. In some implementations, a user associated with a particular department of an industrial plant can only see and access the associated department of the industrial plant, whereas a user with high security clearance, such as a manager or director, can access multiple departments of the industrial plant. In some implementations, a wellness section of the campus can be accessible to all users.

At 306, a selection of a target zone within the campus including XR content is received. The selected zone can be designed to access a project-oriented zone, such as an industrial zone including a digital twin, as described with reference to FIGS. 1C and 1D. The zone can be selected as a selection of a zone identifier or by virtually walking within the displayed outer representation of the selected zone.

At 308, the selected XR content is launched by activating a cross-platform content launcher that facilitates interoperability between platforms through bidirectional deep linking including digital content management that allows for mutual connections between the middleware platform and the XR content of the selected zone. The selected XR content can include an artificial intelligence generated virtual space, such as a customizable virtual office space where human and digital co-workers can collaborate seamlessly. Launching the selected XR content can include uploading the selected XR content on the VR system headset. In some implementations, the authentication information is securely transmitted for connecting and launching the XR content by reformatting the authentication information for transmission into a format that can be processed by the XR hub.

At 310, in response to completing the cross-platform user authentication transmission and in response to uploading the selected XR content on the VR system headset, the virtual display illustrates a transportation to the selected XR content. The transportation to the selected XR content can include a transition frame representing the access of a separate platform or can be a seamless transition from the outer representation of the selected zone (within the campus, such as illustrated in FIGS. 1A and 1B) to the inner representation of the selected zone (including the XR content, such as illustrated in FIG. 1C). The selected XR content can include the display of a portion of an industrial plant (e.g., laboratory, system control room, or a field zone in the proximity of an industrial equipment).

At 312, the selected XR content can include a digital twin that is virtually displayed by the VR headset. The digital twin can match an industrial equipment in a physical environment. The display of the digital twin facilitates a team interaction, an operation adjustment, and safety operational monitoring. The display of the digital twin can simulate an access to a control panel of the digital twin. The display of the digital twin can include a display of one or more adjustable components of the digital twin.

At 314, security and safety parameters are determined based on sensor measurements received from a sensor of the industrial equipment in the physical environment. The security and safety parameters can be determined by an artificial intelligence model trained to identify operational patterns of the industrial equipment and predict potential risks based on the sensor measurements. In some implementations, the display of the digital twin includes a notification indicating a status of the industrial equipment, a prediction of risk associated with a sensor measurement (identified by an artificial intelligence model), and an action plan to remedy the predicted risk.

At 316, an update of operational settings is triggered as an implementation of the parameter modification to the industrial equipment in the physical environment. The digital twin can be updated to match the industrial equipment in the physical environment. In some implementations, the parameter modification of the industrial equipment is transmitted to a remote user device that can be configured to monitor a status of the industrial equipment, as described with reference to FIGS. 1D and 2A.

At 318, the display returns to the virtual campus. In some implementations, an identification of a project completion (industrial equipment repair or finalized meeting) can automatically trigger a transition from the inner representation of the selected zone (including the XR content, such as illustrated in FIG. 1C) to the previous position within the campus, such as the outer representation of the selected zone (within the campus, such as illustrated in FIGS. 1A and 1B).

The example process 300 facilitates unified access to XR content through installed XR applications, improving accessibility relative to a security level. One of the greatest benefits of the example process 300 is maintenance of safe and secure industrial operations, avoiding accidents by bridging the operational adjustment from the digital twin to the industrial equipment. The example process 300 facilitates shared services that simplify the exchange of information and functionalities across different systems. The example process 300 offers centralized updates and support through notifications that can be displayed in any portion of the campus or XR content, reducing industrial equipment downtime and operational overhead.

FIG. 4 depicts a block diagram illustrating a computing system 400, in accordance with some example embodiments. Referring to FIGS. 1A and 1B, the computing system 400 can be used to implement the VR system 102 and/or any other components of the example system 100.

As shown in FIG. 4, the computing system 400 can include a processor 410, a memory 420, a storage device 430, and input/output devices 440. The processor 410, the memory 420, the storage device 430, and the input/output devices 440 can be interconnected using a system bus 450. The processor 410 is capable of processing instructions for execution within the computing system 400. Such executed instructions can implement one or more components of, for example, the example VR system 100. In some implementations of the current subject matter, the processor 410 can be a single-threaded processor. Alternately, the processor 410 can be a multi-threaded processor. The processor 410 is capable of processing instructions stored in the memory 420 and/or on the storage device 430 to display graphical information for a user interface provided using the input/output device 440.

The memory 420 is a computer readable medium such as volatile or non-volatile that stores information within the computing system 400. The memory 420 can store data structures representing configuration object databases, for example. The storage device 430 is capable of providing persistent storage for the computing system 400. The storage device 430 can be a floppy disk device, a hard disk device, an optical disk device, or a tape device, or other suitable persistent storage means. The input/output device 440 provides input/output operations for the computing system 400. In some implementations of the current subject matter, the input/output device 440 includes a keyboard and/or pointing device. In various implementations, the input/output device 440 includes a display unit for displaying graphical user interfaces.

According to some implementations of the current subject matter, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some implementations of the current subject matter, the computing system 400 can be used to execute various interactive computer software applications that can be used for organization, analysis and/or storage of data in various (e.g., tabular) format (e.g., Microsoft Excel®, and/or any other type of software). Alternatively, the computing system 400 can be used to execute any type of software applications. These applications can be used to perform various functionalities, e.g., planning functionalities (e.g., generating, managing, editing of spreadsheet documents, word processing documents, and/or any other objects), computing functionalities, or communications functionalities. The applications can include various add-in functionalities or can be standalone computing products and/or functionalities. Upon activation within the applications, the functionalities can be used to generate the user interface provided using the input/output device 440. The user interface can be generated and presented to a user by the computing system 400 (e.g., on a computer screen monitor).

One or more aspects or features of the subject matter described herein can be realized in digital electronic circuitry, integrated circuitry, specially designed application-specific integrated circuit (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system can include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random-access memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user can provide input to the computer. Other kinds of devices can be used to provide for interaction with a user as well. For example, feedback provided to the user can be any form of sensory feedback, such as for example visual feedback, auditory feedback, or tactile feedback; and input from the user can be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

The preceding figures and accompanying description illustrate example processes and computer implementable techniques. The environments and systems described above (or their software or other components) may contemplate using, implementing, or executing any suitable technique for performing these and other tasks. It can be understood that these processes are for illustration purposes only and that the described or similar techniques may be performed at any appropriate time, including concurrently, individually, in parallel, and/or in combination. In addition, many of the operations in these processes may take place simultaneously, concurrently, in parallel, and/or in different orders than as shown. Moreover, processes may have additional operations, fewer operations, and/or different operations, so long as the methods remain appropriate.

In other words, although the disclosure has been described in terms of certain implementations and generally associated methods, alterations and permutations of these implementations, and methods will be apparent to those skilled in the art. Accordingly, the above description of example implementations does not define or constrain the disclosure. Other changes, substitutions, and alterations are also possible without departing from the spirit and scope of the disclosure.

A number of implementations of the present disclosure have been described. Nevertheless, it will be understood that various modifications may be made without departing from the spirit and scope of the present disclosure. Accordingly, other implementations are within the scope of the following claims.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application.

Example 1. A computer-implemented method, comprising: processing an authentication information for accessing a campus in a virtual reality system, wherein the campus comprises a plurality of locations virtually accessible by a plurality of users relative to a user security level, each location of the plurality of locations being associated with a respective extended reality (XR) content; receiving a first user input comprising a selection of an XR content; securely transmitting the authentication information for connecting and launching the XR content comprising a visualization of a digital twin matching an industrial equipment in a physical environment, the visualization of the digital twin facilitating a team interaction; receiving a second user input comprising a parameter modification of the digital twin; and triggering an implementation of the parameter modification to the industrial equipment in the physical environment.

Example 2. The computer-implemented method of the preceding example, further comprising: displaying, the digital twin using a positional tag indicative of a physical location of industrial equipment in the physical environment.

Example 3. The computer-implemented method of any of the preceding examples, further comprising: receiving, from the industrial equipment in the physical environment, a confirmation of the parameter modification; and updating the digital twin to match the industrial equipment in the physical environment.

Example 4. The computer-implemented method of any of the preceding examples, further comprising: transmitting, to an external computing device, for display the parameter modification to the industrial equipment.

Example 5. The computer-implemented method of any of the preceding examples, wherein the external computing device comprises a mobile device.

Example 6. The computer-implemented method of any of the preceding examples, further comprising: displaying, a list of collaborators actively participating in the team interaction.

Example 7. The computer-implemented method of any of the preceding examples, wherein securely transmitting the authentication information for connecting and launching the XR content comprises reformatting the authentication information for transmission.

Example 8. The computer-implemented method of any of the preceding examples, further comprising: determining a current perspective seen through the virtual reality system based on an orientation of a virtual reality device displaying the virtual reality system; and generating a three-dimensional information based on the current perspective.

Example 9. A computer-implemented system, comprising: a virtual reality system performing operations comprising: processing an authentication information for accessing a campus in a virtual reality system, wherein the campus comprises a plurality of locations virtually accessible by a plurality of users relative to a user security level, each location of the plurality of locations being associated with a respective extended reality (XR) content; receiving a first user input comprising a selection of an XR content; securely transmitting the authentication information for connecting and launching the XR content comprising a visualization of a digital twin matching an industrial equipment in a physical environment, the visualization of the digital twin facilitating a team interaction; receiving a second user input comprising a parameter modification of the digital twin; and triggering an implementation of the parameter modification to the industrial equipment in the physical environment.

Example 10. The computer-implemented system of the preceding example, wherein the operations comprise: displaying, the digital twin using a positional tag indicative of a physical location of industrial equipment in the physical environment.

Example 11. The computer-implemented system of any of the preceding examples, wherein the operations comprise: receiving, from the industrial equipment in the physical environment, a confirmation of the parameter modification; and updating the digital twin to match the industrial equipment in the physical environment.

Example 12. The computer-implemented system of any of the preceding examples, wherein the operations comprise: transmitting, to an external computing device, for display the parameter modification to the industrial equipment.

Example 13. The computer-implemented system of any of the preceding examples, wherein the external computing device comprises a mobile device.

Example 14. The computer-implemented system of any of the preceding examples, wherein the operations comprise: displaying, a list of collaborators actively participating in the team interaction.

Example 15. The computer-implemented system of any of the preceding examples, wherein securely transmitting the authentication information for connecting and launching the XR content comprises reformatting the authentication information for transmission.

Example 16. The computer-implemented system of any of the preceding examples, wherein the operations comprise: determining a current perspective seen through the virtual reality system based on an orientation of a virtual reality device displaying the virtual reality system; and generating a three-dimensional information based on the current perspective.

Example 17.A non-transitory computer-readable media encoded with a computer program, the computer program comprising instructions that when executed by one or more computers cause the one or more computers to perform operations comprising: a virtual reality system performing operations comprising: processing an authentication information for accessing a campus in a virtual reality system, wherein the campus comprises a plurality of locations virtually accessible by a plurality of users relative to a user security level, each location of the plurality of locations being associated with a respective extended reality (XR) content; receiving a first user input comprising a selection of an XR content; securely transmitting the authentication information for connecting and launching the XR content comprising a visualization of a digital twin matching an industrial equipment in a physical environment, the visualization of the digital twin facilitating a team interaction; receiving a second user input comprising a parameter modification of the digital twin; and triggering an implementation of the parameter modification to the industrial equipment in the physical environment.

Example 18. The non-transitory computer-readable media of the preceding example, wherein the operations comprise: displaying, the digital twin using a positional tag indicative of a physical location of industrial equipment in the physical environment.

Example 19. The non-transitory computer-readable media of any of the preceding examples, wherein the operations comprise: receiving, from the industrial equipment in the physical environment, a confirmation of the parameter modification; and updating the digital twin to match the industrial equipment in the physical environment.

Example 20. The non-transitory computer-readable media of any of the preceding examples, wherein the operations comprise: transmitting, to an external computing device, for display the parameter modification to the industrial equipment, wherein the external computing device comprises a mobile device.

1. A computer-implemented method, comprising:
processing an authentication information for accessing a campus in a virtual reality system, wherein the campus comprises a plurality of locations virtually accessible by a plurality of users relative to a user security level, each location of the plurality of locations being associated with a respective extended reality (XR) content;
receiving a first user input comprising a selection of an XR content;
securely transmitting the authentication information across connected applications for connecting and launching the XR content comprising a visualization of a digital twin matching an industrial equipment in a physical environment, the visualization of the digital twin facilitating a team interaction by enabling real-time bidirectional synchronization between the digital twin and the industrial equipment, eliminating redundant logins;
receiving a second user input comprising a parameter modification of the digital twin; and
triggering an implementation of the parameter modification to the industrial equipment in the physical environment.

2. The computer-implemented method of claim 1, further comprising:
displaying, the digital twin using a positional tag indicative of a physical location of industrial equipment in the physical environment.

3. The computer-implemented method of claim 1, further comprising:
receiving, from the industrial equipment in the physical environment, a confirmation of the parameter modification; and
updating the digital twin to match the industrial equipment in the physical environment.

4. The computer-implemented method of claim 1, further comprising:
transmitting, to an external computing device, for display the parameter modification to the industrial equipment.

5. The computer-implemented method of claim 4, wherein the external computing device comprises a mobile device.

6. The computer-implemented method of claim 1, further comprising:
displaying, a list of collaborators actively participating in the team interaction.

7. The computer-implemented method of claim 1, wherein securely transmitting the authentication information for connecting and launching the XR content comprises reformatting the authentication information for transmission.

8. The computer-implemented method of claim 1, further comprising:
determining a current perspective seen through the virtual reality system based on an orientation of a virtual reality device displaying the virtual reality system; and
generating a three-dimensional information based on the current perspective.

9. A computer-implemented system, comprising:
a virtual reality system performing operations comprising:
processing an authentication information for accessing a campus in a virtual reality system, wherein the campus comprises a plurality of locations virtually accessible by a plurality of users relative to a user security level, each location of the plurality of locations being associated with a respective extended reality (XR) content;
receiving a first user input comprising a selection of an XR content;
securely transmitting the authentication information across connected applications for connecting and launching the XR content comprising a visualization of a digital twin matching an industrial equipment in a physical environment, the visualization of the digital twin facilitating a team interaction by enabling real-time bidirectional synchronization between the digital twin and the industrial equipment, eliminating redundant logins;
receiving a second user input comprising a parameter modification of the digital twin; and
triggering an implementation of the parameter modification to the industrial equipment in the physical environment.

10. The computer-implemented system of claim 9, wherein the operations comprise:
displaying, the digital twin using a positional tag indicative of a physical location of industrial equipment in the physical environment.

11. The computer-implemented system of claim 9, wherein the operations comprise:
receiving, from the industrial equipment in the physical environment, a confirmation of the parameter modification; and
updating the digital twin to match the industrial equipment in the physical environment.

12. The computer-implemented system of claim 9, wherein the operations comprise:
transmitting, to an external computing device, for display the parameter modification to the industrial equipment.

13. The computer-implemented system of claim 12, wherein the external computing device comprises a mobile device.

14. The computer-implemented system of claim 9, wherein the operations comprise:
displaying, a list of collaborators actively participating in the team interaction.

15. The computer-implemented system of claim 9, wherein securely transmitting the authentication information for connecting and launching the XR content comprises reformatting the authentication information for transmission.

16. The computer-implemented system of claim 9, wherein the operations comprise:
determining a current perspective seen through the virtual reality system based on an orientation of a virtual reality device displaying the virtual reality system; and
generating a three-dimensional information based on the current perspective.

17. A non-transitory computer-readable media encoded with a computer program, the computer program comprising instructions that when executed by one or more computers cause the one or more computers to perform operations comprising: a virtual reality system performing operations comprising:
processing an authentication information for accessing a campus in a virtual reality system, wherein the campus comprises a plurality of locations virtually accessible by a plurality of users relative to a user security level, each location of the plurality of locations being associated with a respective extended reality (XR) content;
receiving a first user input comprising a selection of an XR content;
securely transmitting the authentication information across connected applications for connecting and launching the XR content comprising a visualization of a digital twin matching an industrial equipment in a physical environment, the visualization of the digital twin facilitating a team interaction by enabling real-time bidirectional synchronization between the digital twin and the industrial equipment, eliminating redundant logins;
receiving a second user input comprising a parameter modification of the digital twin; and
triggering an implementation of the parameter modification to the industrial equipment in the physical environment.

18. The non-transitory computer-readable media of claim 17, wherein the operations comprise:
displaying, the digital twin using a positional tag indicative of a physical location of industrial equipment in the physical environment.

19. The non-transitory computer-readable media of claim 17, wherein the operations comprise:
receiving, from the industrial equipment in the physical environment, a confirmation of the parameter modification; and
updating the digital twin to match the industrial equipment in the physical environment.

20. The non-transitory computer-readable media of claim 17, wherein the operations comprise:
transmitting, to an external computing device, for display the parameter modification to the industrial equipment, wherein the external computing device comprises a mobile device.
